(19) United States
(12) Patent Application Publication
(10) Pub. No.: US 2025/0236401 A1
(43) Pub. Date: Jul. 24, 2025

(54) ELECTRIC PROPULSION SYSTEMS

(71) Applicant: GREENJETS LIMITED, Hertfordshire (GB)

(72) Inventors: Guido MONTERZINO, Cambridgeshire (GB); Arava Anmol MANOHAR, Buckinghamshire (GB)

(21) Appl. No.: 18/856,530

(22) PCT Filed: Apr. 13, 2023
(86) PCT No.: PCT/GB2023/050995

§ 371 Date: Oct. 11, 2024

(30) Foreign Application Priority Data
Apr. 13, 2022 (GB) 2205502.4

(51) Int. Cl. B64D 27/34; B64C 11/00; B64D 27/355; B64D 27/357; B64D 33/08

(52) U.S. Cl. CPC B64D 27/34; B64C 11/001; B64D 27/355; B64D 27/357; B64D 33/08

(57) ABSTRACT

Examples provide an electric propulsion system; the system comprising a nacelle comprising an aerodynamic annular housing defining an internal annular volume and defining an inner duct, only a single one fan stage comprising a fan bearing a plurality of aerodynamic surfaces/blades to generate thrust, and a powertrain comprising at least one electric motor to drive the fan and at least one electrical power source to power the electric motor; and wherein the fan is disposed within the inner duct and the powertrain is disposed within the internal annular volume.

### BACKGROUND

There is an increasing drive to reduce carbon emissions to combat global warming. Part of that drive involves improving the efficiency of existing gas turbine engines and internal combustion engines of, for example, aircraft. Alternative propulsion technologies are also being investigated such as, for example, electric propulsion systems. Ground vehicles that use electric motors are well-established. However, aircraft that use electric motors to drive aerodynamic surfaces are less well established and face a number of technical challenges such as the relatively low energy density of electrical energy sources, lower power densities of batteries and inherent inefficiencies such as thermal management systems, power losses and other inefficiencies.

### BRIEF INTRODUCTION OF THE DRAWINGS

Examples will be described with reference to the accompanying drawings in which

FIG. 1 shows an electric propulsion system according to a first example;

FIG. 2 illustrates an electric propulsion system according to a second example;

FIG. 3 depicts an electric propulsion system according to a third example;

FIG. 4 shows an electric propulsion system according to a fourth example;

FIG. 5 illustrates an electric propulsion system according to a fifth example;

FIG. 6 depicts an electric propulsion system according to a sixth example;

FIG. 7 shows an electric propulsion system according to a seventh example;

FIG. 8 illustrates an electric propulsion system according to a eighth example;

FIG. 9 depicts an electric propulsion system according to a ninth example;

FIG. 10 shows an electric propulsion system according to a tenth example;

FIG. 11 shows an electric propulsion system according to a eleventh example;

FIG. 12 illustrates an electric propulsion system according to a twelfth example;

FIG. 13 depicts an electric propulsion system according to a thirteenth example;

FIG. 14 shows an electric propulsion system according to a fourteenth example;

FIG. 15 illustrates an electric propulsion system according to a fifteenth example;

FIG. 16 depicts an electric propulsion system according to a sixteenth example;

FIG. 17 shows an electric propulsion system according to a seventeenth example;

FIGS. 18 and 19 illustrate an electric propulsion system according to an eighteenth example,

FIG. 20 depicts a view of the inlet guide vanes according to an example;

FIG. 21 shows a view of the outlet guide vanes according to an example;

FIG. 22 illustrates a view of a fan shroud according to an example;

FIG. 23 shows a sectional view of the fan shroud of FIG. 22;

FIG. 24 illustrates a view of a fan shroud according to examples; and

FIG. 25 shows a sectional view of the fan shroud of FIG. 24.

### DETAILED DESCRIPTION

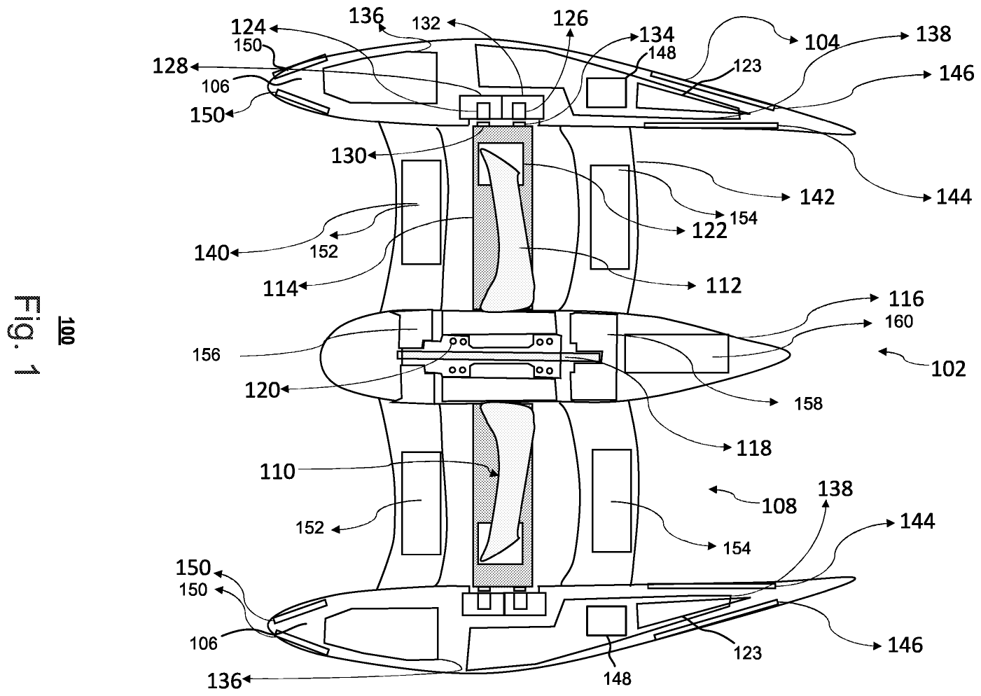

Referring to FIG. 1 there is shown a view 100 of an electric propulsion system 102. The electric propulsion system can be for an aircraft. The electric propulsion system 102 comprises a nacelle 104. The nacelle 104 comprises an aerodynamic annular housing. The annular housing defines an internal annular volume 106. The annular housing also defines an inner duct indicated generally as 108. The inner duct is external to the housing and forms an airflow path through which air passes. The electric propulsion system 102 comprises at least one fan stage 110. The fan stage has a plurality of aerodynamic surfaces or blades 112 for generating thrust. The blades 112 are mounted to an annular fan shroud 114. The fan shroud 114 is mounted on a central hub 116 so that the fan comprising the blades 112 can rotate about a central shaft 118. The fan stage 110 is mounted to the central shaft via a bearing system 120. The bearing system 120 is rotatable about the central shaft 118. Each of the blades 112 is mounted to the fan shroud 114 via a respective fixture 122. Using a fan shroud can reduce noise generation that is otherwise associated with open tip blades. The noise reduction can be realised, at least in part, using sound absorbing materials to form the nacelle housing. Further noise reductions can be realised by profiling a profiled trailing edge geometry to the nacelle 104. The profiled trailing edge bears features such as, for example, a Helmholtz Resonator muffler 123, that reduce aero-electric noise associated with operating the propulsion system 102. The Helmholtz Resonator muffler 123 is arranged to suppress large amplitude and mid to low frequency pressure fluctuations such as, for example, mechanical vibratory noise of aerodynamic bodies immersed in a propulsive medium and buffeting noise arising at an engine intake.

The electric propulsion system 102 comprises a powertrain having at least one electric motor to drive the fan stage 110 via the fan shroud 114. The powertrain is housed within the inner annular volume 106. Also housed within the inner annular volume 106 is at least one electrical power source to power the at least one electric motor. In the example illustrated, a pair of electric motors 124 and 126 is provided. A first electric motor 124 comprises a set of stator coils 128 that are arranged to cooperate with a set of rotor magnets 130. The second electric motor 126 comprises a set of stator coils 132. The second set of stator coils 132 is arranged to cooperate with a second set of rotor magnets 134. The first 124 and second 126 electric motors are operable independently, jointly and singly. The first set of rotor magnets 130 are mounted on the fan shroud 114. The first set of magnets 130 transfer torque from the first electric motor stator coils 128 to cause rotation of the fan shroud 114. The second set of rotor magnets 132 transfer torque from the second electric motor stator coils 132 to cause rotation of the fan shroud 114. Therefore, the fan shroud can be driven by either electric motor alone or simultaneously with the other electric motor. The electric motors can drive the fan shroud independently of one another. The magnets 130 and 134 can be arranged in a Hallbach array embedded in the fan shroud. The nacelle 104, as well as producing thrust, acts as structural housing for the powertrain. The nacelle 104 also functions as a safety shroud that protects the vehicle against blade failure.

The internal volume 106 of the nacelle 104 houses the powertrain for driving the fan stage 110. Examples can be realised in which the powertrain comprises at least one or more than one of: at least one electric motor, at least one electrical power source to power the at least one electric motor, an engine control unit, at least one inverter, a power distribution system, a thermal management system, a fuel cell, taken jointly and severally in any and all permutations.

As indicated above the powertrain comprises at least one electrical power source 136. The at least one electrical power source 136 can comprise an energy storage system. The energy storage system can comprise at least one battery.

The nacelle 104 comprises a further internal volume 138. The further internal volume 138 is arranged to accommodate at least one or more than one of: a power distribution system, an engine control unit, a thermal management system, a fire protection system, a de-icing system, taken jointly and severally in any and all permutations.

Examples can be realised in which the electric propulsion system has a UniTwin topology, that is, a single fan stage or, a single fan, is driven by twin motors that are operable independently, and simultaneously, or singularly. The above pair of electric motors 124 and 126 together with the single fan shroud 114 represent an example of a UniTwin topology.

The central hub 116 is coupled to the nacelle 104 via a number of load transfer members. Examples can be realised in which the number of load transfer members comprises a set of fore, or inlet, guide vanes 140. Examples can be realised additionally, or alternatively, in which the load transfer members comprise a set of aft, or exit, guide vanes 142. The load transfer members are arranged to transfer thrust generated by the blades 112 to the rest of the electric propulsion system 102 and, ultimately, to a vehicle bearing such a propulsion system. The exit guide vanes can be used as control surfaces to enable the thrust to be vectored, which can be used to manoeuvre an associated vehicle such as an aircraft.

The aft portion of the nacelle 104 comprises at least one heat exchanger. In the example shown the aft portion of the nacelle 104 comprises sets of heat exchangers. A first set of heat exchangers 144 is disposed on an inward facing surface of the nacelle housing. The first set of heat exchangers 144 is arranged to couple heat from the powertrain to the air contained within the inner duct 104. Coupling heat from the powertrain to the air within the inner duct 108 causes that air to expand and, therefore, to contribute to generating thrust. The aft portion of the nacelle comprises a further set of heat exchangers 146. The further set of heat exchangers 146 is arranged to couple heat from the powertrain and vent it to atmosphere in order to manage the thermal conditions within the powertrain.

Any and all examples can be realised in which the heat exchangers 144 have surface features that suppress noise associated any boundary layer of the downstream flow within the inner duct. The surface features can comprise undulations on the inwardly directed surfaces of the heater exchangers 114. Examples can be realised in which the undulations present a ribbed texture surface or airflow interface. The undulations can comprise microscale structures, such as, for example, dentils, arranged to create longitudinal grooves. The size and pitch of these grooves is a function of an expected local velocity and density of the medium flowing through the nacelle. Any or each of the examples described herein can be realised comprising such microstructures in the range of 100 to 300 μm in depth and 30 to 40 μm in width. Examples presenting such a textured or profiled surface realise boundary layer noise attenuation as well as local skin friction reduction. Examples can be realised in which such attenuation follows without incurring a specific heat exchange penalty.

A thermal management system 148 is provided to manage the thermal conditions associated with the powertrain. A common thermal management system is used to manage the thermal conditions associated with each element, or at least with selectable elements, of the powertrain. The thermal management system 148 uses liquid coolant, such as, for example, a dielectric fluid to transfer heat away from any such elements of the powertrain and to direct that heat to at least one, or both, of the first 144 and second 146 sets of heat exchangers. Having a common thermal management system 148 supports collecting or harvesting heat from one or more than one component of the electric propulsion system, in particular, the powertrain such as, for example, one or more than one of: any motor or motors, any battery or batteries, any power electronics such as any inverter or inverters taken jointly and severally in any and all permutations, which saves weight and complexity.

The thermal management system 148 can also direct heat generated by the powertrain to a set of heaters, or to at least one set of heaters. For example, the thermal management system 148 can direct heat generated by the powertrain to de-icing heaters 150 associated with the leading edge of a fore section of the nacelle 104. The de-icing heaters 150 are arranged to de-ice the nacelle. Examples can also be realised in which the thermal management system 148 can couple heat to at least one, or both, of the load transfer members 140 and/or 142, or the blades 112. The thermal management system 148 can couple heat from the powertrain to heaters or heat exchangers 152 and/or 154 in the inlet 140 and exit 142 guide vanes. Furthermore, the thermal management system 148 can couple heat from the powertrain to the central hub 116 via a respective heater or respective heat exchanger 158.

An effective way of realising lightweight motors for a given power is to increase the revolutions per minute and to reduce the torque since electric motors are sized according to torque. To introduce electric redundancy into the electric propulsion system 102, examples can be realised in which the two independent motors 124 and 126 are capable of spinning at a high RPM, that is, that are capable of spinning above a threshold level RPM. Examples can be realised in which the threshold level RPM would be a speed above 2,000 RPM and below 60,000 RPM. Examples can be realised in which the motors are arranged to generate fan speeds of between 2,000 and 3,000 RPM. It can be appreciated that the electric motors 124 and 126 are both rim driven electric motors that independently, and can simultaneously, drive the single fan stage 110. Aerodynamic efficiency is realised by ensuring that the single fan stage 110 operates at RPMs of above 2000. It can be appreciated that electrical redundancy is achieved through the two electric motors 124 and 126 independently driving the fan stage 110. Coupling torque from the electric motors 124 and 126 to the fan stage 110 can use axial flux or radial flux motor architectures.

As indicated above the interior volume of the nacelle 104 can comprise a powertrain having a fuel cell, that is, can comprise a fuel cell powertrain. Several advantages follow from including a fuel cell powertrain in the interior of the nacelle 104. For example, electrical cabling within an aircraft needed by the propulsion system can be reduced thereby leaving space for hydrogen storage and distribution systems. Furthermore plug and play propulsion, that is, electricity generation to thrust generation in a propulsor, supports quick replacement of the powertrain that, in turn, can reduce aircraft downtime for operators.

It can be appreciated that the load transfer members 140 and 142 are coupled to respective structures 156 and 158 for transferring load from the rotor fan stage 114 to the inlet guide vanes 140 and exit guide vanes 142.

The electric propulsion system 102 can use a rim driven motor system to drive the fan stage as opposed to a hub-driven motor in traditional electric powertrains. The stator coils 128 and 130 are located inside the duct while the sets of rotors, that is, permanent magnets, are embedded on to a ring that forms the outer tip of the rotating fan stage. There are several advantages of using a rim driven system. Firstly, the motor is installed in the duct next to the battery pack instead of being installed in the hub that removes the need for high-power cable connections that would otherwise increase weight and decrease efficiency. Secondly, the motor, inverter and battery share at least one of: power management, thermal management, structural housing, and protection equipment, taken jointly and severally in any and all permutations, thereby leading to further weight and efficiency gains. Thirdly, since the hub does not contain an electric motor, it can be designed for high aerodynamic efficiency and also used to house the mechanical bearings for the fans. Another advantage is that tip losses are lower than in hub-driven systems, which, again, leads to higher aerodynamic efficiency. Furthermore, as the motors are direct drive, the rotational speeds are relatively low. Normally low rotational speeds require a high torque and heavy electric motor because, in traditional systems, the motor has to have a large radius. In contrast, according to examples described herein, the motor size can be small and lightweight while still producing the required torque. The motors 124 and 126 can, therefore, be accommodated within the inner volume 106 of the nacelle 104.

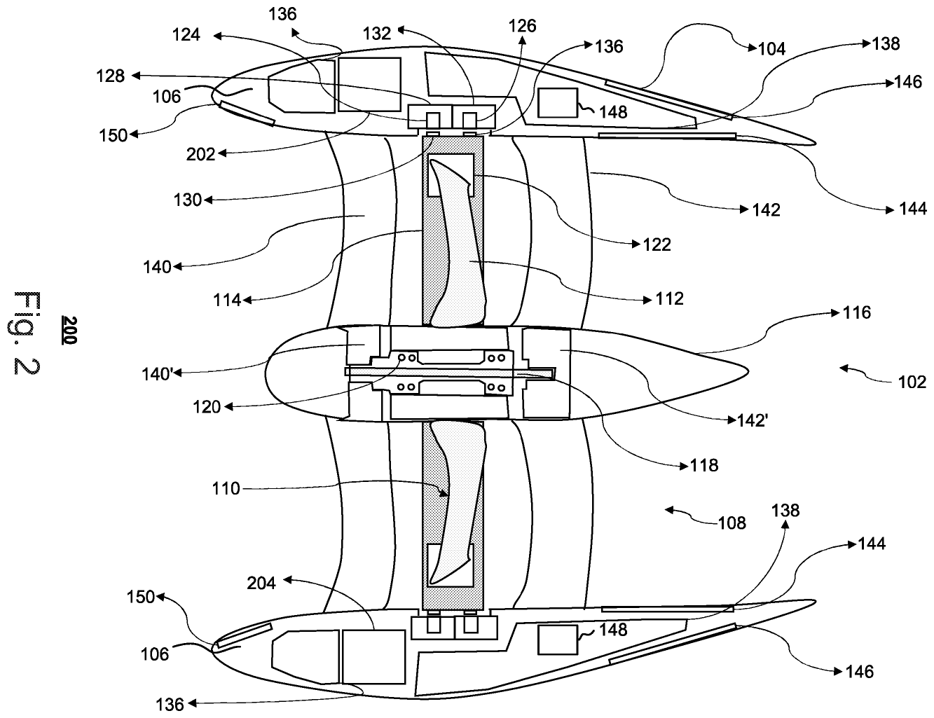

Referring to FIG. 2, there is shown a view 200 of an electric propulsion system 102 according to an example.

Reference numerals common to FIGS. 1 and 2 refer to the same elements.

The electric propulsion system 102 comprises one or more than one fuel cell. In the example depicted, two fuel cells 202 and 204 are illustrated. Although the example shown illustrates two fuel cells 202 and 204, examples are not limited to such an arrangement. Examples can be realised in which multiple fuel cells are positioned within the annular space 106 defined by the nacelle housing 104. Examples can be realised in which a single fuel cell is provided that has an annular shape. Alternatively, or additionally, the one or more than one fuel cell 202 and 204 can comprise annular segments disposed within the interior annular space defined by the nacelle 104.

There are several advantages to including a fuel cell in the inner volume 106 of the nacelle 104 such as, for example, increasing payload volume in the aircraft. Furthermore, all electrical cabling in the aircraft needed by the propulsion system can be reduced since the distance between the fuel cell and any electric motors is reduced, which leaves space within the aircraft for fuel storage for the fuel to power the fuel cell such as hydrogen storage and hydrogen distribution systems.

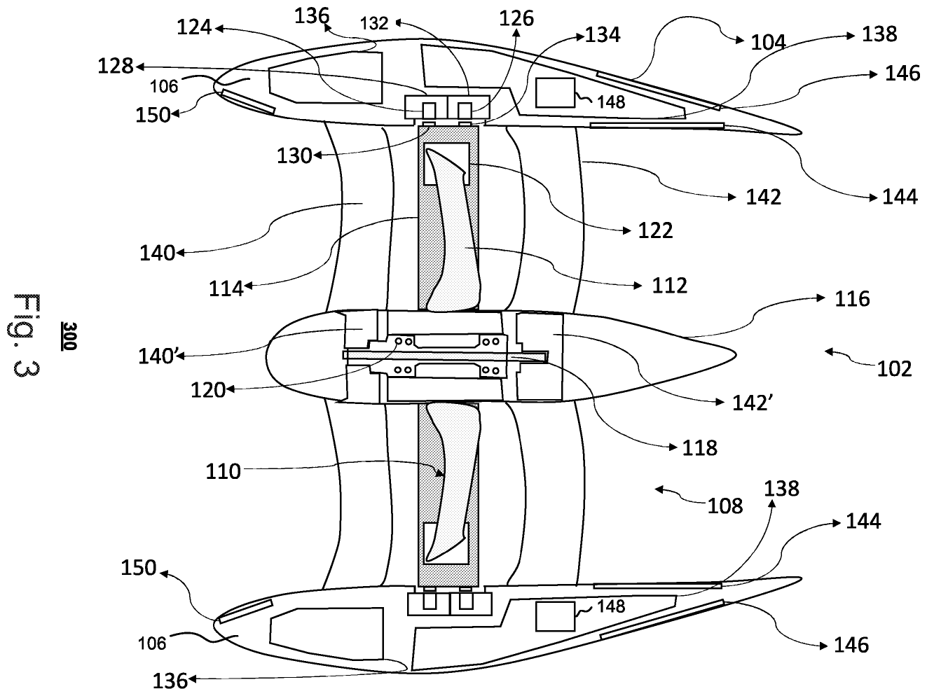

Referring to FIG. 3, there is shown a view 300 of an electric propulsion system 102 according to an example. Reference numerals common to FIG. 3 and FIG. 1 refer to the same elements.

The electric motors 124 and 126 and the corresponding first 130 and second 134 sets of rotor magnets are radially arranged, that is, the electric motors 124 and 126 have a radial flux topology. Such an arrangement allows the fan stage 110, or fan structure, to be readily removed without needing to disassemble the entire electric propulsion system 102.

It can be seen that the rotor magnets 130 and 134 are radially inwardly disposed relative to the stator coils 128 and 132.

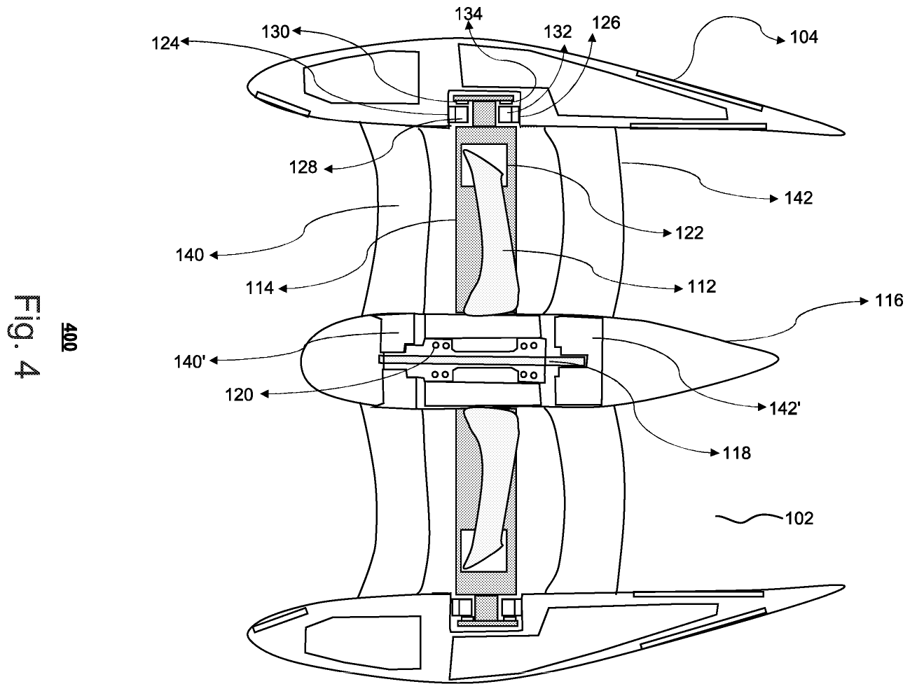

In the example depicted in FIG. 4 there is shown a view 400 of an electric propulsion system 102 according to an example. Reference numerals common to FIG. 4 and FIG. 1 refer to the same element.

Again, a UniTwin arrangement is shown. The UniTwin arrangement comprises the first 124 and second 126 electric motors. The first and second 124 and 126 electric motors comprise respective stator coils 128 and 132. The stator coils 128 and 132 are radially inwardly disposed relative to respective sets relative to a first set 130 and a second set 132 of respective rotor magnets. Advantageously, as the fan stage rotates, the radius of rotation of the fan stage 110 increases, which increases the air gap between the first set of stator coils 128 and the respective set of rotor magnets 130 and the second set of stator coils 132 and the respective set of rotor magnets 134. Since the rotor magnets are radially outwardly disposed relative to the stators, any such expansion reduces, or avoids, a risk of propulsion system failure due to contact between moving parts and stationary parts of the electric propulsion system, in particular, between the stators 128 and 132 and the respective rotor magnets 130 and 134.

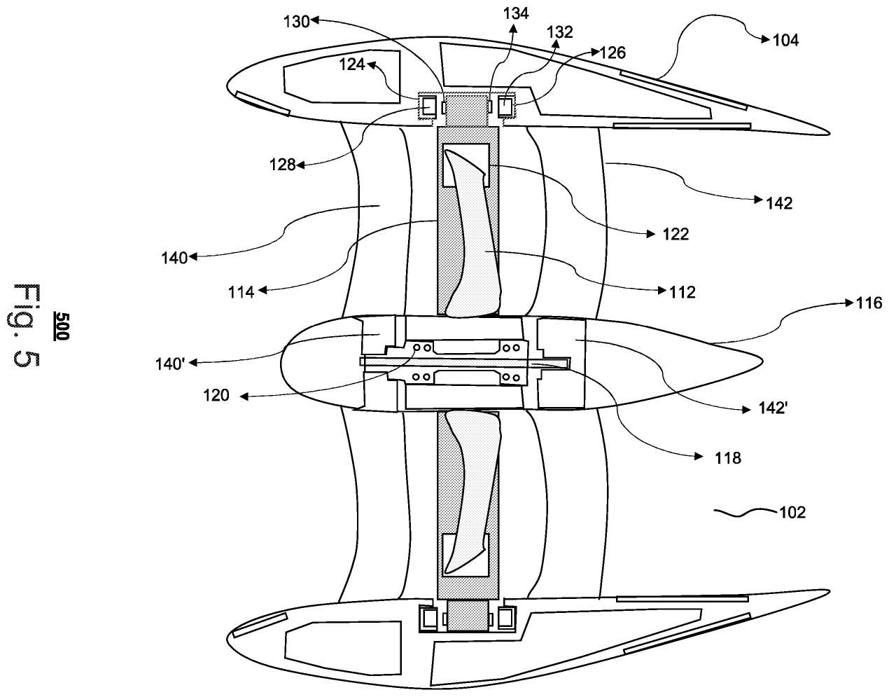

Referring to FIG. 5, there is shown a view 500 of an electric propulsion system 102. Reference numerals common to FIG. 5 and any of the preceding figures refer to the same elements. It can be appreciated that the UniTwin arrangement comprises an axial flux motor topology. The first electric motor 124 comprises a set of stators coils 128 and a corresponding set of rotor magnets 130. The set of stator coils and the set of rotor magnets 130 are axially disposed. In the example illustrated, the set of stators 128 are disposed in an axially aft position relative to the set of rotors 130. The set of rotor magnets 130 are disposed on the fan shroud 110.

The second electric motor 126 comprises a set of stator coils 132 that cooperate with a set of rotor magnets 134; the latter being mounted to the fan stage 110 or fan shroud. Again, as with the first motor 124, the set of stator coils 126 and the set of rotor magnets 134 are axially disposed relative to one another with the set of stator coils being disposed axially aft of the set of rotor magnets 134.

Advantageously, such an axial flux electric motor topology decouples expansion of the fan stage during rotation from any adverse influence on motor operations such as, for example, an increased magnetic air gap; the latter affecting motor efficiency adversely as the air gap increases.

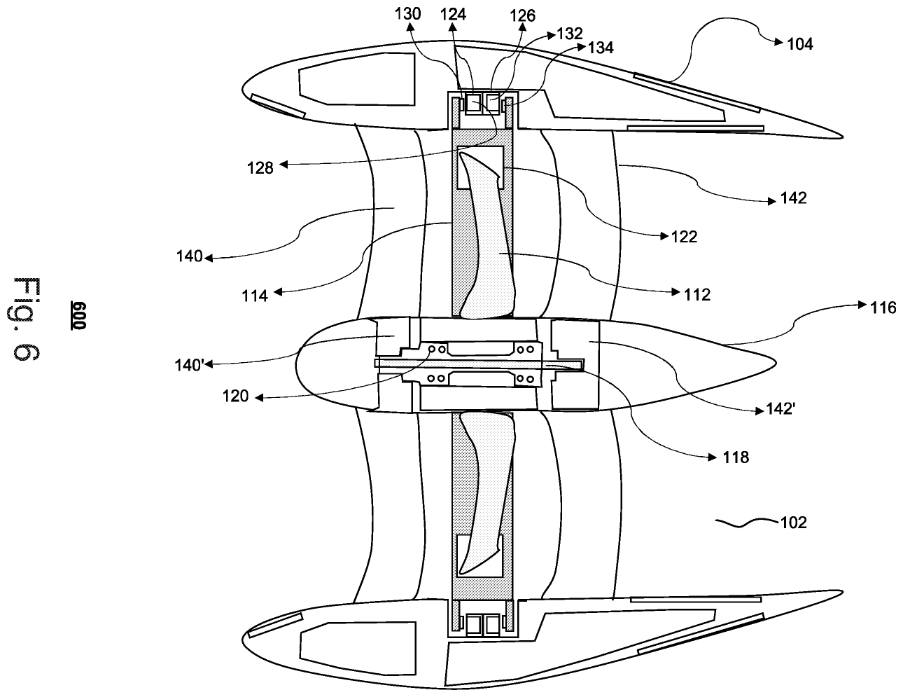

Referring to FIG. 6, there is shown a view 600 of an electric propulsion system 102. The reference numerals common to FIG. 6 and any preceding figure refer to the same element.

Again, the electric motors are arranged in an axial flux motor topology. A first electric motor 124 comprises a set of stator coils mounted within the nacelle interior volume 106. The set of stator coils 128 cooperate with a respective set of rotor magnets 130. The rotor magnets 130 are mounted to the fan stage 110.

A second electric motor 126 is provided. The second electric motor 126 comprises a set of stator coils 132 that cooperate with a set of rotor magnets 134. The rotor magnets 134 are mounted to the fan stage or fan shroud 110. In the example depicted in FIG. 6, the stator coils are positioned between the sets of rotor magnets 130 and 134. The sets of rotor magnets 130 and 134 are axially outwardly disposed relative to the stator coils 128 and 132.

Again, such a topology decouples any variation in magnetic air gap from rotor, or fan shroud/fan stage, expansion.

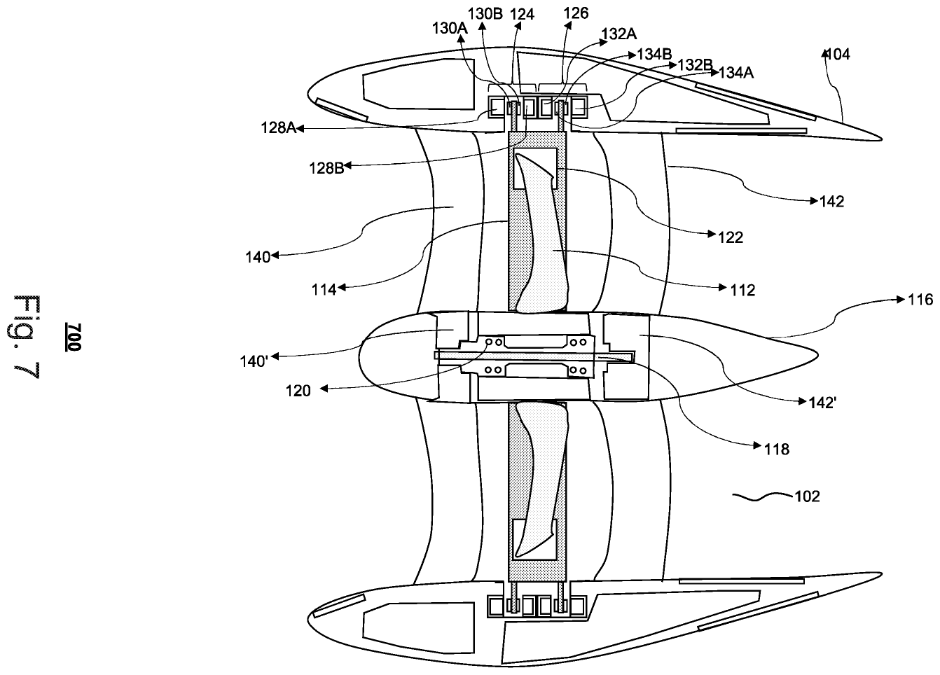

Referring to FIG. 7, there is shown a view 700 of an electric propulsion system 102. Reference numerals common to FIG. 7 and any preceding figure refer to the same element.

The electric motor topology is a UniTwin axial flux motor topology in which two electric motors 128 and 126 are provided to drive the fan stage 110. The first electric motor 124 comprises two sets of stator coils 128A and 128B. The two sets of stator coils 128A and 128B cooperate with respective sets of rotor magnets 130A and 130B. The first 128A and second 128B sets of stator coils are outwardly axially disposed relative to the axially inwardly positioned sets of rotor magnets 138A and 138B.

The second motor 126, similarly, comprises two sets of stator coils 132A and 132B. The first 132A and second 132B sets of stator coils cooperate with respective first 134A and second 134B sets of rotor magnets. Again, the rotor magnets are positioned between the stator coils 132A and 132B.

Since each motor 124 and 126 has a dual stator, the respective rotors are held in position axially, thereby reducing gyroscopic imbalances.

Again, the axial motor topologies shown in FIG. 7 decouple variation in air gap, and therefore, adverse efficiency, from radial expansion of the fan stage.

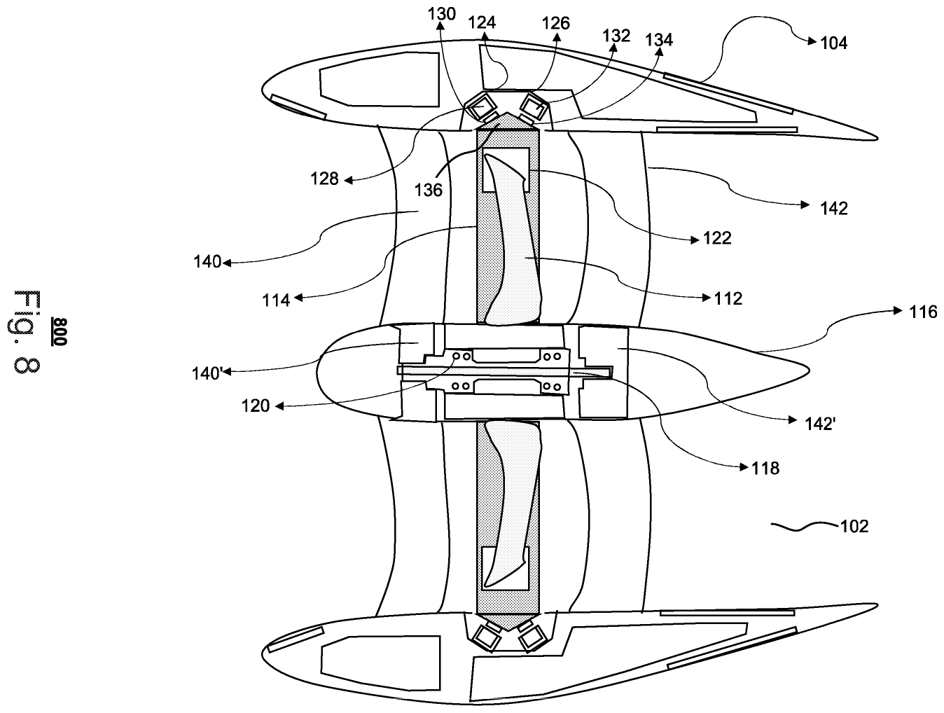

Referring to FIG. 8, there is shown a view 800 of an electric propulsion system 102 according to an example. Reference numerals common to FIG. 8 and any preceding figure refer to the same element.

The motor topology is a UniTwin conical flux, convex rotor topology comprising a pair or twin set of electric motors. The pair or twin set of electric motors comprises a first electric motor 124 and a second electric motor 126. The electric motors are operable independently, and simultaneously, to drive the fan stage 110.

The first electric motor 124 comprises a set of stator coils 128. The set of stator coils is arranged to cooperate with a respective set of rotor magnets 130. The rotor magnets are mounted to the fan stage 110. The set of stator coils 128 and the set of rotor magnets 130 are arranged in a conical arrangement, that is, the set of stator coils are positioned axially aft, and radially outwardly, relative to the set of rotor magnets 130.

The second electric motor 126 is arranged in a similar manner to the first electric motor 124. The second electric motor comprises a set of stator coils 132. The set of stator coils 132 are arranged to cooperate with a respective set of rotor magnets 134. The set of stator coils 132 are disposed axially aft, and radially outward, relative to the set of rotor magnets 134. Such a motor topology has the advantage that the motor electromagnets also act as magnetic bearings for the fan stage 110.

The first electric motor 124 and second electric motor 126 are mounted to a circular cant 136. The circular cant 136 can be a complete circular cant or be formed from spaced circular cant segments. The circular cant 136 is example of a convex cant. Examples can be realised in which multiple stator-rotor pairs are present on the cant and, therefore, two or more rows of rotor magnets are arranged on the convex face of the rotor shroud presented by the cant 136. An advantage of having the stator-to-rotor interface region implemented on a convex rotor surface can be increased motor efficiency under varying load conditions and particularly in long transients.

Any of the circular cants described herein can be complete circular cants or can be formed from spaced circular cant segments.

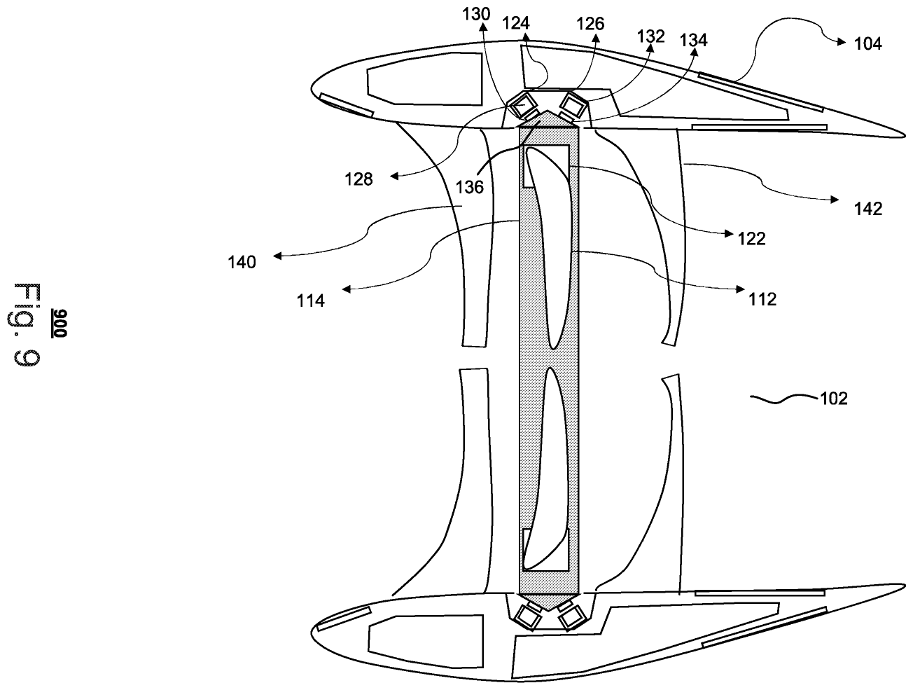

Referring to FIG. 9, there is shown a view 900 of an electric propulsion system 102 according to an example. Reference numerals common to FIG. 9 and any preceding figure refer to the same element.

The example electric propulsion system 102 depicted in FIG. 9 is a hub-less design in which the hub 116 of the previous examples has been removed.

As with FIG. 8, the electric propulsion system 102 of FIG. 9 comprises a conical flux motor topology that is identical to the example described above with reference to FIG. 8.

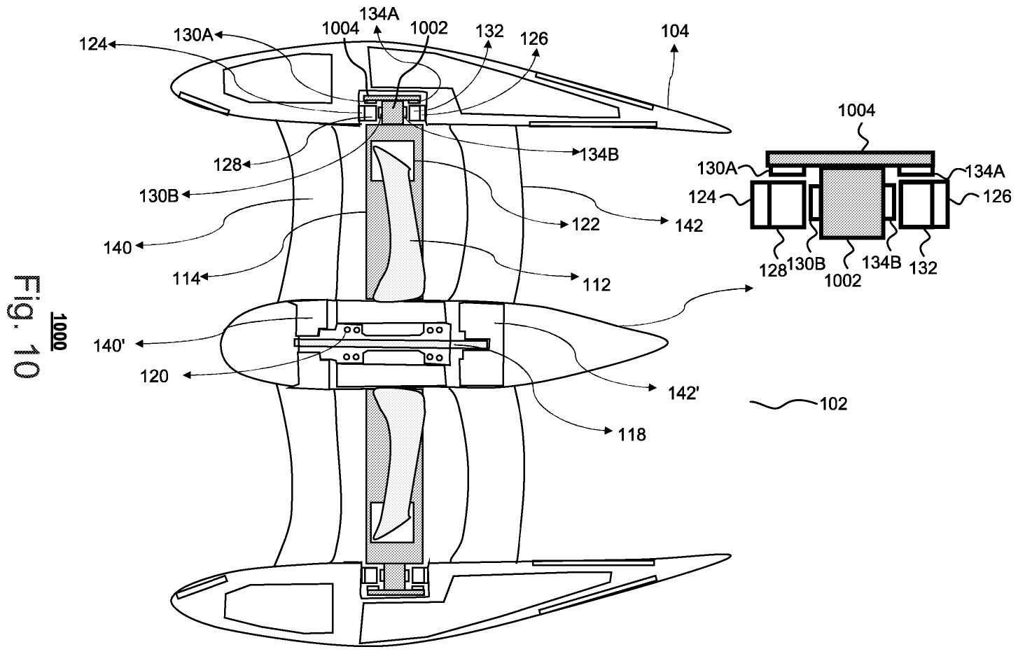

Referring to FIG. 10, there is shown a view 1000 of an example of the electric propulsion system 102. Reference numerals common to FIG. 10 and any preceding figure refer to the same element.

The electric propulsion system 102 comprises a pair of electric motors 124 and 126.

A first electric motor 124 comprises a set of stator coils 128. The set of stator coils 128 is arranged to cooperate with a plurality of sets of rotor magnets. The plurality of sets of rotor magnets are mounted to the fan shroud 114. In the example depicted, the plurality of sets of rotor magnets comprises a first set of rotor magnets 130A and a second set of rotor magnets 130B. The first set of rotor magnets 130A are radially outwardly disposed relative to the stator coils 128, that is, in a radial flux arrangement. The second set of rotor magnets 130B are axially aft relative to the stator coils 128, that is, in an axial flux arrangement.

A second electric motor 126 comprises a set of stator coils 132. The set of stator coils 132 is arranged to cooperate with a plurality of sets of rotor magnets. The plurality of sets of rotor magnets are mounted to the fan shroud 114. In the example depicted, the plurality of sets of rotor magnets comprises a first set of rotor magnets 134A and a second set of rotor magnets 134B. The first set of rotor magnets 134A are radially outwardly disposed relative to the stator coils 132, that is, in a radial flux arrangement. The second set of rotor magnets 134B are axially fore relative to the stator coils 132, that is, in an axial flux arrangement.

The outer portion of the fan shroud 114 comprises a radially extending ring or central web 1002 coupled to an axially extending cylinder 1004. The axially extending cylinder 1004 carries the rotor magnets 130A and 134A. The radially extending ring 1002 carries the rotor magnets 130B and 134B.

It can be appreciated that each stator 128 and 132 comprises respective pluralities of sets of rotor magnets. The respective pluralities of sets of rotor magnets are arranged orthogonally relative to one another. The first motor 124 comprises a stator 128 that cooperates with the respective sets 130A and 130B of rotor magnets. The respective sets 130A and 130B of rotor magnets are orthogonally disposed relative to one another to form a motor topology that uses both radial flux and axial flux. The first motor 126 comprises the stator 132 that cooperates with the respective sets 134A and 134B of rotor magnets. The respective sets 134A and 134B of rotor magnets are orthogonally disposed relative to one another to form a motor topology that uses both radial flux and axial flux.

Equipping the centre web 1002 with axial flux rotor magnets on either side implements a dual-stator axial flux machine. The superposition of the two separate types of electrical machine, that is, the radial flux machines, which is also known as the outrunner motors, and the axial flux machines, that is, the dual stator inner rotor (DSIR) motors, provides advantages in torque summation, such as, for example, the addition of torque from multiple stators without the need for a gearbox, and in rotor transient stability, that is, for example, radial expansion of the shroud during operations decrease the magnetic air gap, which improves torque transfer to the rotor, through the opportunity for increased guidance of peripheral rotor surfaces, that is, the magnetic arrangement provides accurate positioning of the rotor as a by-product of torque transfer, given by the increased exchange of magnetic forces, where the increase is due to the use of both axial and radial magnetic forces applied instead of just one or the other.

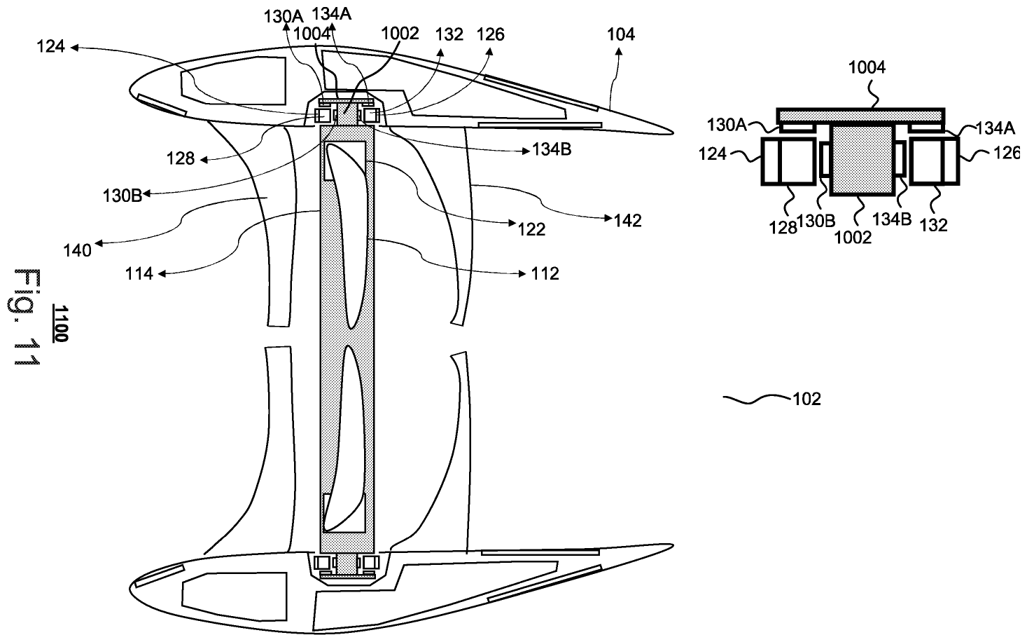

Referring to FIG. 11, there is shown a view 1100 of an example of the electric propulsion system 102. Reference numerals common to FIGS. 11 and 10 refer to the same element.

The only difference between FIGS. 10 and 11 is that the latter is a hub-less electric propulsion system.

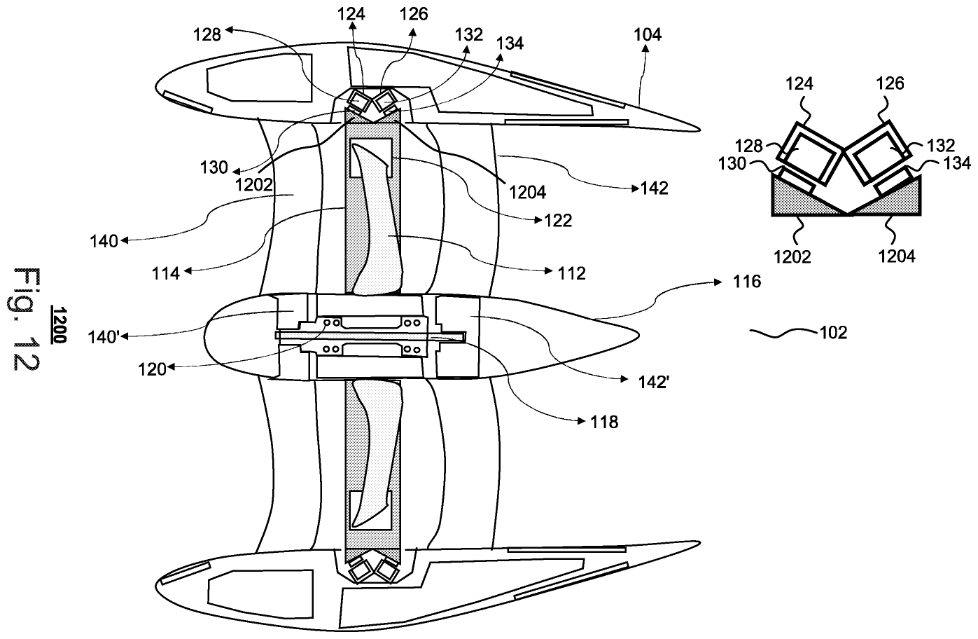

Referring to FIG. 12, there is shown a view 1200 of an example of the electric propulsion system 102. Reference numerals common to FIG. 12 and any preceding figure refer to the same element.

The electric propulsion system 102 comprises a pair of electric motors 124 and 126.

A first electric motor 124 comprises a set of stator coils 128. The set of stator coils 128 is arranged to cooperate with a set of rotor magnets. The set of rotor magnets are mounted to the fan shroud 114. In the example depicted, the set of rotor magnets comprises a first set of rotor magnets 130. The first set of rotor magnets 130 are radially inwardly disposed relative to, and axially fore of, stator coils 128, that is, in a conical flux arrangement.

A second electric motor 126 comprises a set of stator coils 132. The set of stator coils 132 is arranged to cooperate with a set of rotor magnets. The set of rotor magnets are mounted to the fan shroud 114. In the example depicted, the set of rotor magnets comprises a first set of rotor magnets 134. The first set of rotor magnets 134 are radially inwardly disposed relative to, and axially aft of, the stator coils 132, that is, in a conical flux arrangement. The first electric motor 124 is disposed axially fore relative to the second electric motor 126.

The outer portion of the fan shroud 114 comprises a pair of radially extending cants or conical or rings 1202 and 1204. A first cant or conical ring 1202 carries the set of rotor magnets 130 of the first electric motor 124. A second cant or conical ring 1204 carries the set of rotor magnets 134 of the second electric motor 126.

The first electric motor 124 and second electric motor 126 are mounted to respective circular cants 1202 and 1204. The circular cants 1202 and 1204 can be complete circular cants or be formed from spaced circular cant segments. The circular cants 1202 and 1204 form an overall concaved cant comprising the two circular cants 1202 and 1204. Examples can be realised in which multiple stator-rotor pairs are present either cant or on both cants and, therefore, two or more rows of rotor magnets are arranged on the concaved face of the rotor shroud presented by the cants 1202 and 1204. Advantages of having the stator-to-rotor interface region implemented on a concave rotor surface can comprising at least one or more than one of the following taken jointly and severally in any and all permutations: an increased rotor stability under varying load conditions and/or, in particular, in gyroscopic reaction transients, which occur when the aircraft undertakes gyroscopic manoeuvres, and an enhanced rotor damping coefficient as the driving magnetic forces exchanged between stator and rotor are parallel to the direction of gyroscopic precession motion, unlike the case of the convex rotor where these forces are orthogonal.

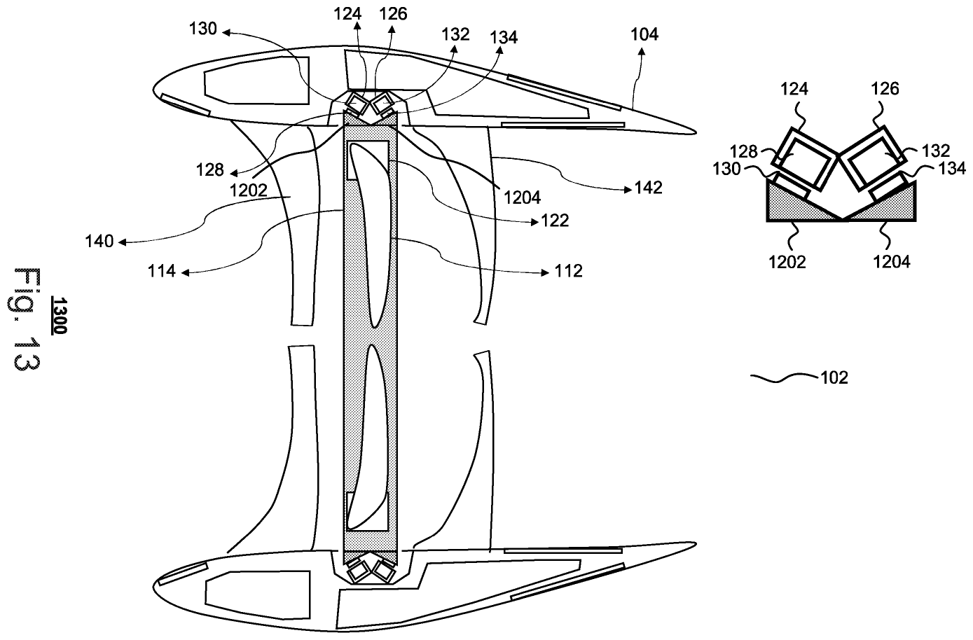

Referring to FIG. 13, there is shown a view 1300 of an example of the electric propulsion system 102. Reference numerals common to FIGS. 13 and 12 refer to the same element.

The only difference between FIGS. 12 and 13 is that the latter is a hub-less electric propulsion system.

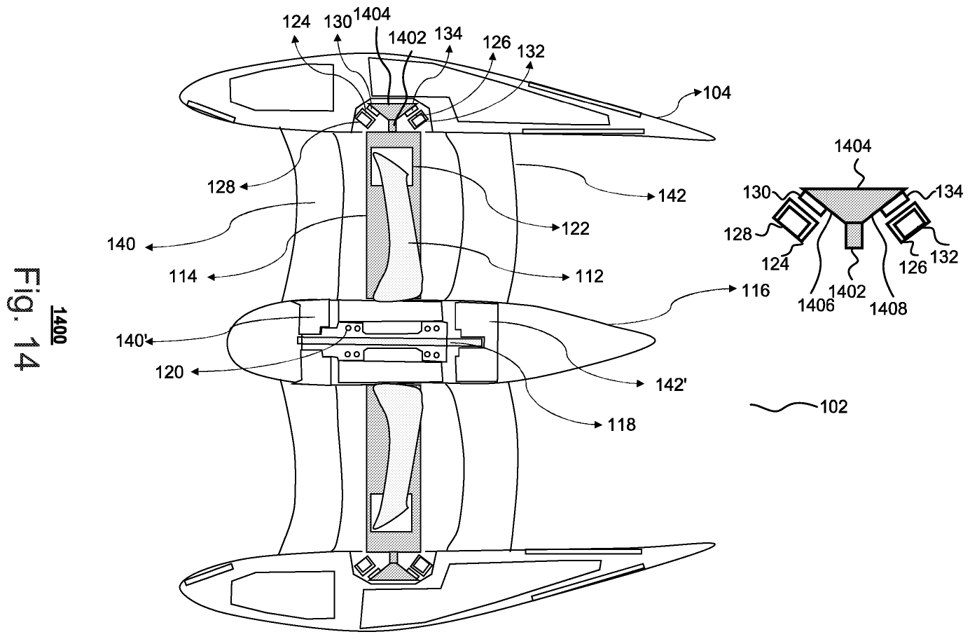

Referring to FIG. 14, there is shown a view 1400 of an example of the electric propulsion system 102. Reference numerals common to FIG. 14 and any preceding figure refer to the same element.

The electric propulsion system 102 of FIG. 14 comprises a pair of electric motors 124 and 126.

A first electric motor 124 comprises a set of stator coils 128. The set of stator coils 128 is arranged to cooperate with a set of rotor magnets. The set of rotor magnets are mounted to the fan shroud 114. In the example depicted, the set of rotor magnets comprises a first set of rotor magnets 130. The first set of rotor magnets 130 are radially outwardly disposed relative to, and axially aft of, stator coils 128, that is, in a conical flux arrangement.

A second electric motor 126 comprises a set of stator coils 132. The set of stator coils 132 is arranged to cooperate with a set of rotor magnets. The set of rotor magnets are mounted to the fan shroud 114. In the example depicted, the set of rotor magnets comprises a first set of rotor magnets 134. The first set of rotor magnets 134 are radially outwardly disposed relative to, and axially fore of, the stator coils 132, that is, in a conical flux arrangement. The first electric motor 124 is disposed axially fore relative to the second electric motor 126.

The outer portion of the fan shroud 114 comprises a ring 1402 carrying a conical ring or cant 1404. The conical ring 1404 bears pair of radially inward facing surfaces 1406 and 1408. A first inward facing surface 1406 of the conical ring 1404 carries the set of rotor magnets 130 of the first electric motor 124. A second inward facing surface 1408 of the conical ring 1404 carries the set of rotor magnets 134 of the second electric motor 126.

Therefore, it can be appreciated that motors 124 and 126 have a conical flux topology that is realised using the cant angle presented by the conical ring. The conical rings 1404 presents a convex geometry. The convex geometry is radially inwardly directed. Having such a stator/rotor arrangement can result in at least one, or more than one, of: increased motor efficiency under varying load conditions and, particularly, in long transients, such as, for example, as the stator and rotor air gap reduces with radial expansion of the fan blades and shroud, and reducing, or avoiding, any tensional strain in the magnets/magnet assembly since the load on the magnets/magnet assembly and the respective bonding that binds the magnets to the shroud is compressive, which, in turn, avoids or reduced the need for banding that can be used to otherwise hold the magnets to the shroud.

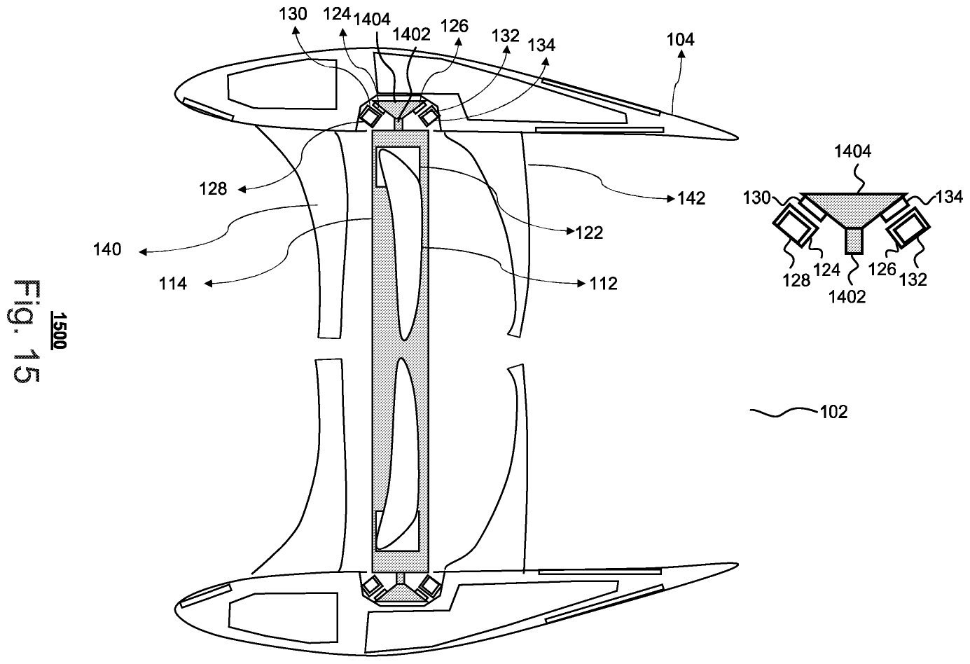

Referring to FIG. 15, there is shown a view 1500 of an example of the electric propulsion system 102. Reference numerals common to FIGS. 15 and 14 refer to the same element.

The only difference between FIGS. 14 and 15 is that the latter is a hub-less electric propulsion system. The observations made above relating to FIG. 14 are equally applicable to FIG. 15.

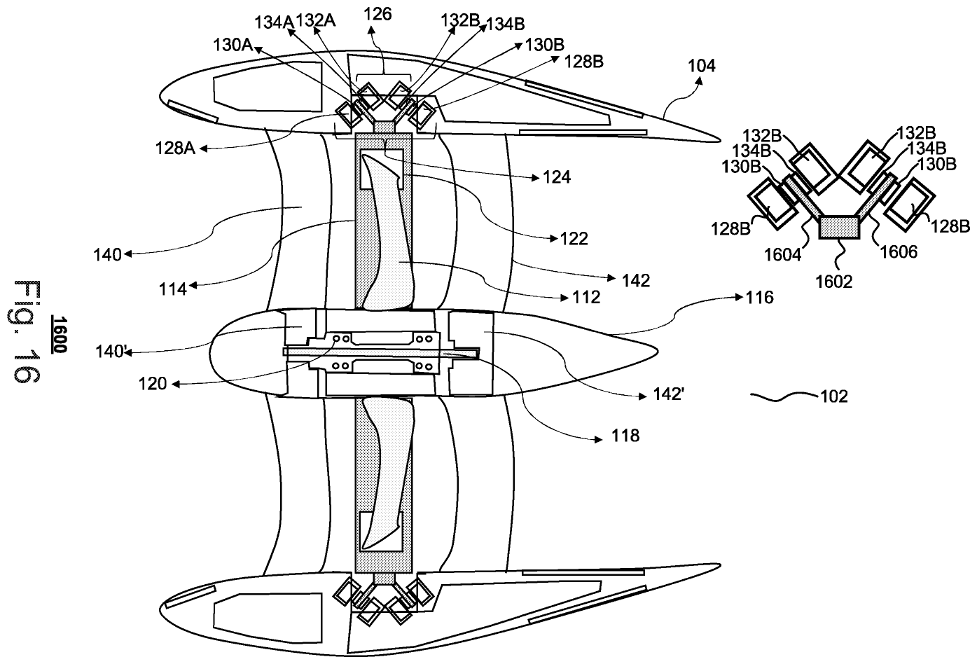

Referring to FIG. 16, there is shown a view 1600 of an example of the electric propulsion system 102. Reference numerals common to FIG. 16 and any other figure refer to the same elements.

The electric propulsion system 102 of FIG. 16 comprises a pair of electric motors 124 and 126.

A first electric motor 124, known as an outer-V electric motor, comprises a plurality of sets of stator coils. In the example shown, two sets of stator coils 128A and 128B are depicted. The sets of stator coils 128A and 128B are arranged to cooperate with a plurality of sets of rotor magnets. In the example shown, two sets of rotor magnets 130A and 130B are depicted. The sets of rotor magnets 130A and 130B are mounted to the fan shroud 114 as described below. In the example depicted, a first set of rotor magnets 130A is radially outwardly disposed relative to, and axially aft of, a respective first set of stator coils 128A, that is, in a conical flux arrangement and a second set of rotor magnets 130B is radially outwardly disposed relative to, and axially fore of, a respective second set of stator coils 128B, that is, in a conical flux arrangement.

A second electric motor 126, known as an inner-V electric motor, comprises a plurality of sets of stator coils. In the example shown, two sets of stator coils 132A and 132B are depicted. The sets of stator coils 132A and 132B are arranged to cooperate with a plurality of sets of rotor magnets. In the example shown, two sets of rotor magnets 134A and 134B are depicted. The sets of rotor magnets 134A and 134B are mounted to the fan shroud 114 as described below. In the example depicted, a first set of rotor magnets 134A is radially inwardly disposed relative to, and axially fore of, a respective first set of stator coils 132A, that is, in a conical flux arrangement and a second set of rotor magnets 134B is radially inwardly disposed relative to, and axially aft of, a respective second set of stator coils 132B, that is, in a conical flux arrangement.

The outer portion of the fan shroud 114 comprises a ring 1602 carrying a pair of frustoconical rings 1604 and 1606. A first frustoconical ring 1604 is concaved when viewed axially in a leading edge to trailing edge direction. A second frustoconical ring 1606 is concaved when viewed axially in a trailing edge to leading edge direction. The first frustoconical ring 1604 carries the sets of rotor magnets 130A and 134A of the first and second electric motors 124 and 126 respectively. The second frustoconical ring 1606 carries the sets of rotor magnets 130B and 134B of the first and second electric motors 124 and 126 respectively.

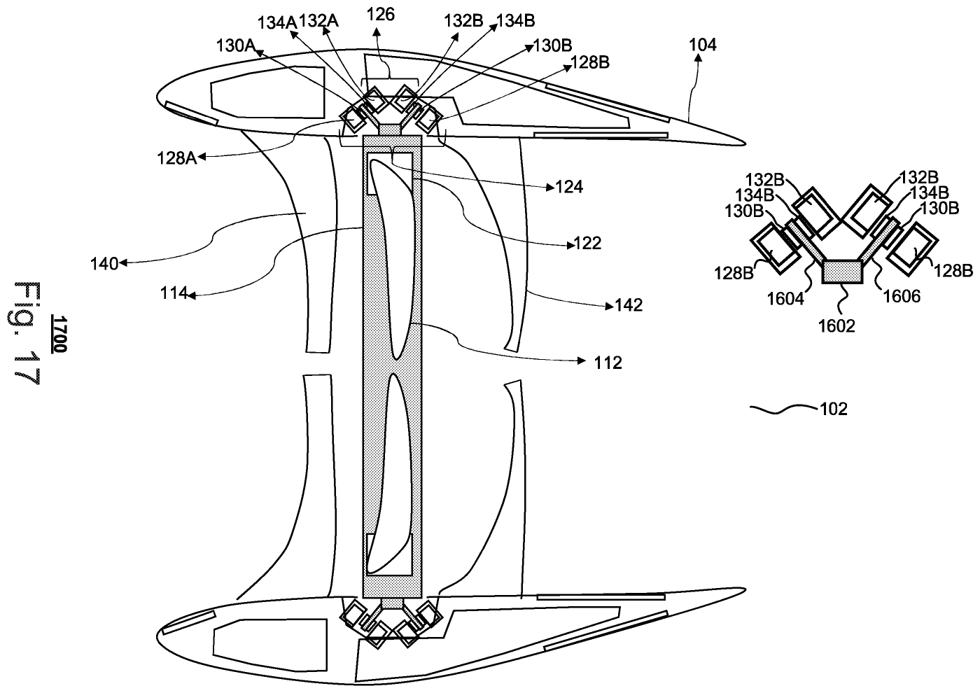

The arrangement of an outer V-electric motor 124 and an inner V-electric motor 126 results in at least one, or more than one of the following, taken jointly and severally in any and all permutations: 1) torque summation advantages, which are achieved via the addition of torque from two or more stators into one or more rotors without the need of a gearbox, 2) increased rotor stability under varying load conditions and particularly in gyroscopic reaction transients such as, for an example when the aircraft undertakes gyroscopic manoeuvres, and 3) the opportunity to specialise the inner/outer V-machines for different roles in the overall motor system such as, for example, at least one, or both, of the following: the inner V-machine 126 may be arranged to provide more support to reduce, or minimise, shaft loads, whereas the outer V-machine 124 may be arranged to provide more drive or propulsion, which can make this configuration suitable for potential hubless applications, as described below with reference to FIG. 17. Furthermore, the examples of FIGS. 16 and 17 can provide a superior rotor damping coefficient relative to the examples described above with reference to FIGS. 14 and 15 since the examples depicted in FIGS. 16 and 17 comprise multiple sets of stator-rotor pairs whose exchanged magnetic forces are parallel to the direction of gyroscopic precession motion.

Referring to FIG. 17, there is shown a view 1700 of an example of the electric propulsion system 102. Reference numerals common to FIGS. 17 and 16 refer to the same element.

The only difference between FIGS. 16 and 17 is that the latter is a hub-less electric propulsion system. The observations made above relating to FIG. 16 are equally applicable to FIG. 17.

Although the twin motors 124 and 126 have been described in the above examples as being adjacent to one another, but offset axially or radially, examples are not limited thereto. Examples can be realised in which any and all motors are circumferentially offset relative to one another. In such an arrangement, the two, or more, motors 124 and 126 are arranged in a common ring, but offset by a predetermined angle. Examples can be realised in which the motors are offset by 15 degrees.

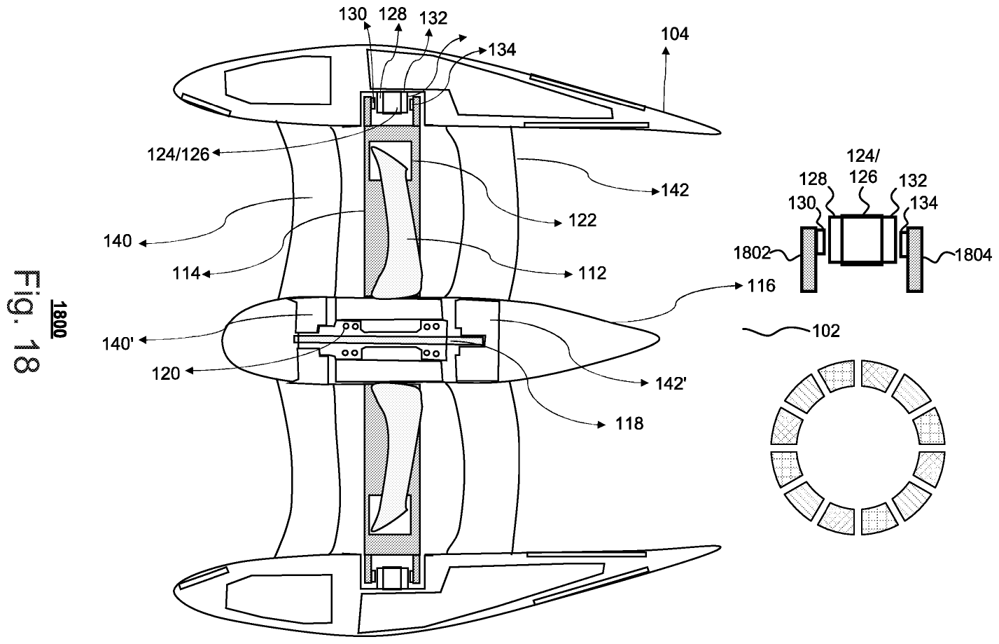

Referring to FIG. 18, there is shown a view 1800 of an example of the propulsion system 102 comprising circumferentially offset motors 124 and 126.

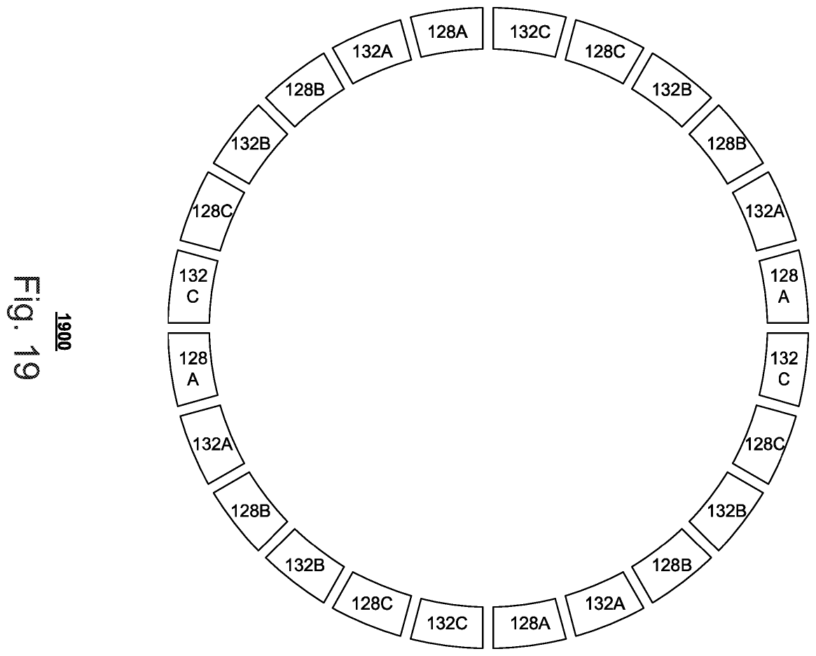

A first motor 124 of the example of FIG. 18 comprises a plurality of stator windings 128. An example of such stator windings 128 is described below with reference to FIG. 19. The stator windings 128 are arranged to cooperate with a set of rotor magnets 130. The set of rotor magnets 130 can be mounted on the fore or leading flange 1802. Examples can be realised in which the set of rotor magnets 130 can be mounted one at least one, or both, of fore and aft flanges 1802 and 1804.

A second motor 126 of the example of FIG. 18 comprises a plurality of stator windings 132. An example of such stator windings 132 is described below with reference to FIG. 19. The stator windings 132 are arranged to cooperate with a set of rotor magnets 134. The set of rotor magnets 134 can be mounted on the trailing flange 1804. The set of rotor magnets 134 can be mounted on at least one, or both, of the fore and aft flanges 1802 and 1804.

The stator windings 128 and 132 of the two motors 124 and 126 are offset by a predetermined angle. The predetermined angle can be, for example, 15 degrees.

The two motors 124 and 126, as with the other examples, can operating independently of one another to drive the fan shroud 114.

FIG. 19 shows a view 1900 of the three-phase windings 128 and 132 of the two motors 124 and 126 described above with reference to FIG. 18. The windings of the first motor 124 are indicated using the numeral “128”. The windings of the second motor 126 are indicated using the numeral “132”. The three phases of a given motor are indicated using A, B and C. Therefore, the stator windings of the first motor 124 are designed using 128A, 128B and 128C and the stator windings of the second motor 126 are designated using 132A, 132B and 132C.

Although the example depicted in FIG. 18 shows a propulsion system 102 comprising a central hub 116, examples are not limited thereto. Examples can be realised in which the propulsion system 102 is hub-less.

The examples described with reference to FIGS. 18 and 19 provide sets of circumferentially disposed segmented stators corresponding to respective motors of a plurality of motors such as the two motors 124 and 126 shown.

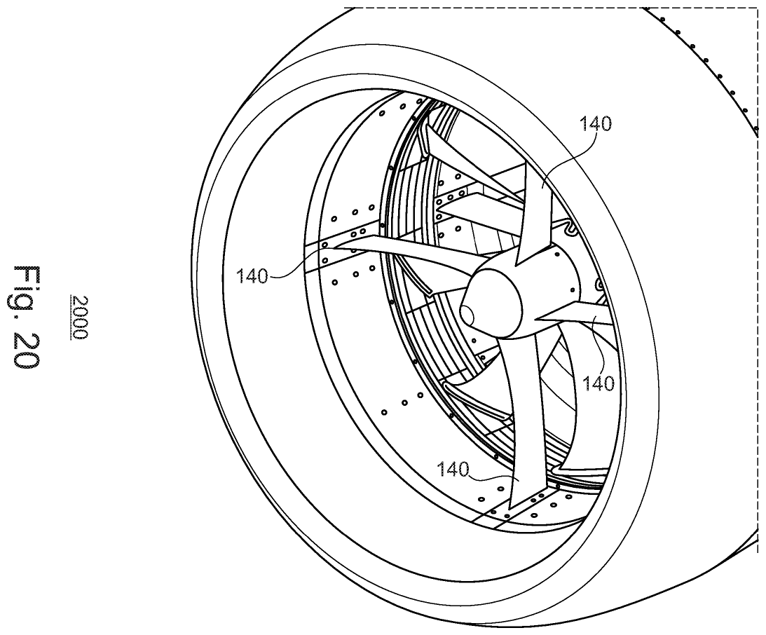

Referring to FIG. 20, there is shown a view 2000 of an electric propulsion system such as any of the systems described herein more clearly depicting the set of inlet guide vanes. In the example shown, the set of inlet guide vanes comprises four inlet guide vanes 140.

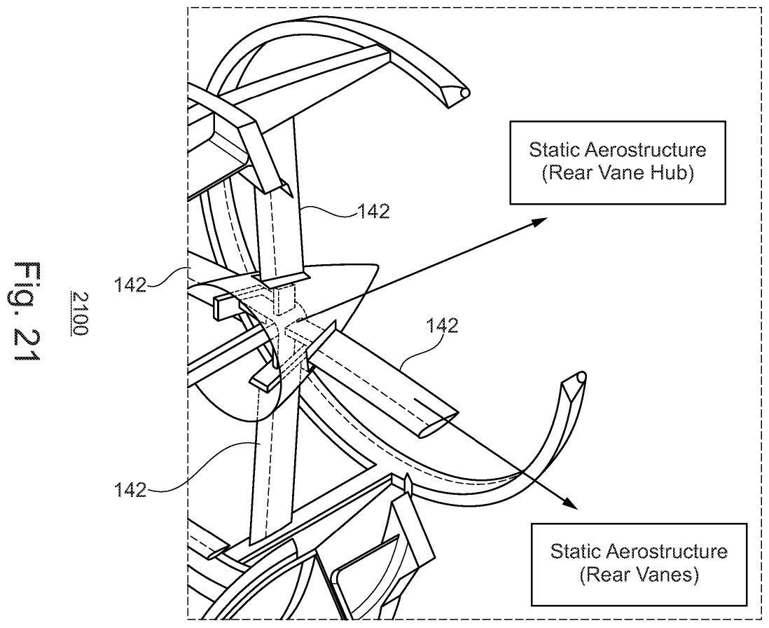

Referring to FIG. 21, there is shown a view 2100 of an electric propulsion system such as any of the systems described herein more clearly depicting the set of outlet or exit guide vanes. In the example shown, the set of outlet or exit guide vanes comprises four outlet or exit guide vanes 140.

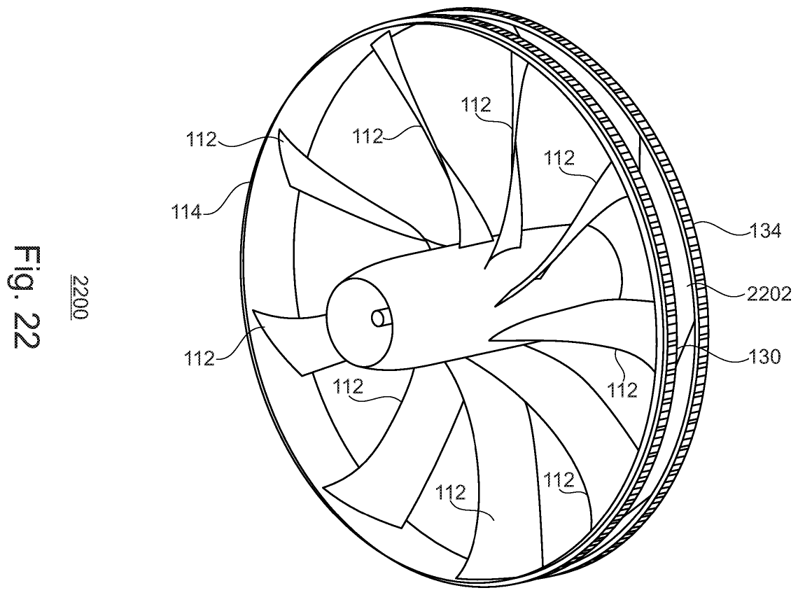

Referring to FIG. 22, there is shown a view 2200 of a fan shroud 114 of any and all the examples described and/or claimed herein. The fan shroud 114 comprises a set of aerodynamic surfaces 112 for generating thrust. In the example fan shroud 114 depicted in FIG. 22, the set of aerodynamic surfaces comprises nine blades 112. The outer cylindrical surface 2202 of the fan shroud 114 bears the sets of permanent magnets 130 and 134 associated with the twin electric motors.

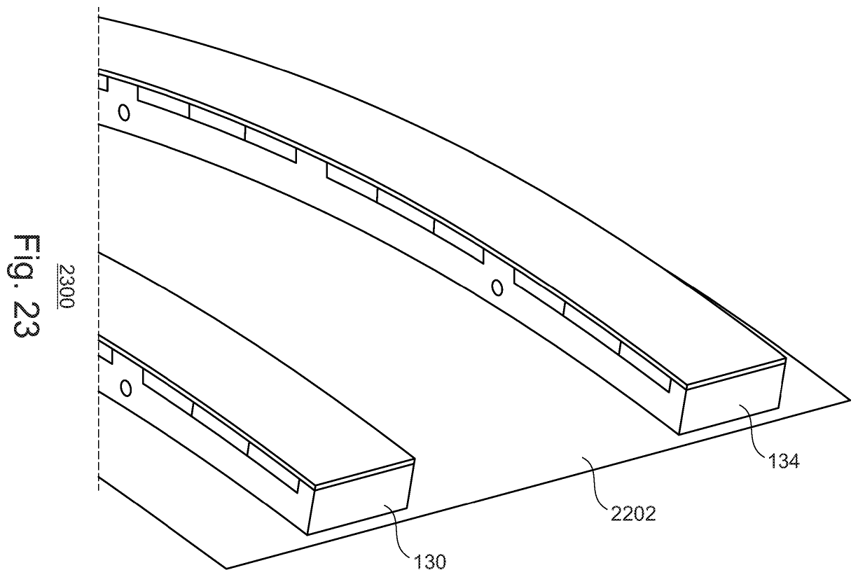

FIG. 23 shows a view 2300 of a part of the shroud 114 of FIG. 22 depicting a closer views of the sets of rotor magnet 130 and 134.

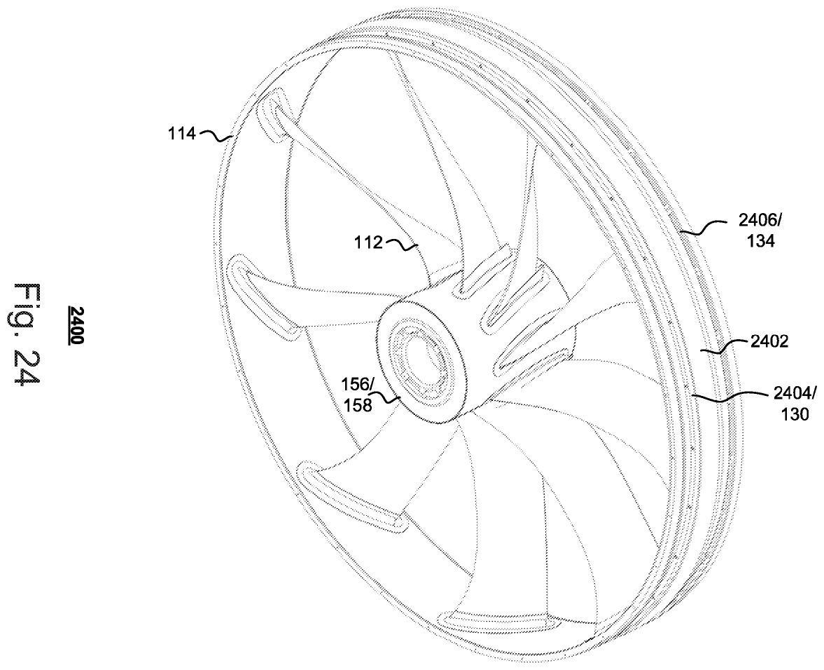

Referring to FIG. 24, there is shown a view 2400 of an example of a further fan shroud 114 that can be used with any and all examples described and/or claimed herein. The fan shroud 114 comprises a set of aerodynamic surfaces 112 for generating thrust. In the example fan shroud 114 depicted in FIG. 24, the set of aerodynamic surfaces comprises nine blades 112. The outer cylindrical surface 2402 of the fan shroud 114 bears sets of permanent magnets 2404 and 2406 associated with the twin electric motors. The sets of permanent magnets 2404 and 2406 are examples of the above permanent magnets 130 and 134 respectively.

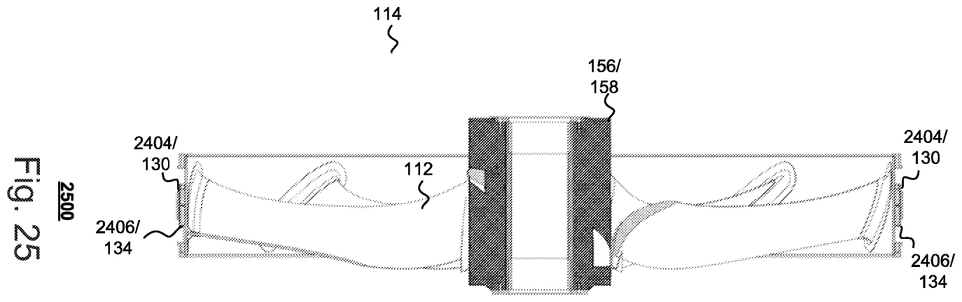

Referring to FIG. 25, there is shown a view 2500 of a section through the fan shroud 114 depicted in FIG. 24. The shroud 114 has at least one set of the rotor magnets disposed circumferentially around the outer surface 2402 of the shroud 114. The example depicted in FIG. 24 has two sets 2404 and 2406 of such circumferentially disposed rotor magnets that cooperate with respective sets of stator magnets in a twin motor topology. The sets 2404 and 2406 of rotor magnets are examples of the above described rotor magnets 130 and 134 respectively.

The electric propulsion systems can be used for all classes of aircraft and ground vehicles that use an electric motor(s) to drive aerodynamic surfaces that produce thrust, which includes all VTOL (vertical take-off and landing), CTOL (conventional take-off and landing), STOL (short take-off and landing), STOVL (short take-off and vertical landing) aircraft, hovercraft, airships, and transportation devices that produce thrust via an electric powertrain. The energy source on the aircraft might be maybe an electrochemical battery, hydrogen driving a fuel cell or internal combustion engine generator, any carbon fuel driving a generator (gas turbine/internal combustion engine) or any other source. Examples of such aircraft include Volocopter™, Ehang™, Lilium™, Airbus Vahana™, Bell Nexus™, Eviation Alice™. The use of an electric propulsion enables many novel vehicle configurations with unique advantages that are not possible with traditional powertrains such as gas turbines and internal combustion engines. At the same time, there are several challenges with these classes of vehicles, such as low energy density of certain electrical energy sources (e.g. electro-chemical), heavy thermal management systems (low grade heat rejection), heavy cabling amongst others that are surmounted using the propulsion system according to the examples described herein.

Furthermore, many known electric powertrains for ducted propulsors for aircraft are distributed across the aircraft. The energy storage, typically a battery pack or fuel cell, is located in the fuselage or within the wing structures. Long cables then connect the battery packs to the inverters. The inverters, in turn, connect to the electric motor via cables and the motor then drives a propeller or a ducted fan to generate thrust. There are several inefficiencies these arrangement that are surmounted by the electric propulsion systems according to the examples described herein.

The weight of cabling can be between 1/10th and ⅕th the overall weight of the powertrain. Additionally, the cabling can cause up to 5-10% of overall power loss due to its internal resistance.

Still further, since each component of the powertrain is located independently of the other components, each requires its own housing structure, thermal management system and protection equipment. These can further increase overall powertrain weight to the point where the overall power density and energy density of the aircraft is very low. Again, the example electric propulsions systems described here surmount those technical challenges.

Additionally, the heat generated from each element of the powertrain, namely, any batteries, any motors, and inverters, is usually wasted into the ambient air. This loss can be up to 10-15% of overall power and can significantly affect overall powertrain performance. Again, the example electric propulsion systems described herein surmount that technical problem by harvesting heat from the powertrain to perform useful functions such as, for example, de-icing or increasing thrust.

All of the above problems result in low aircraft range and endurance. In a few electric aircraft classes such as eVTOLs, there is not enough power/energy available to get the aircraft of the ground when the requirement for reserve power is also considered.

The examples described herein can be realised so that an entire powertrain is embedded within a single unit, or are positioned close to one another, the cabling is reduced compared to a powertrain comprising more distributed components. Furthermore, the close proximity of the components of the powertrain allow at least one of: the mechanical housing, thermal management systems and protection equipment, taken jointly and severally in any and all permutations, to be shared, which leads to an overall weight reduction.

Example that use a battery or battery pack are the electrical energy source provide high power density (W/m3) but at low specific energy (J/kg) and energy density (W/m3). Since the battery or batter pack is located inside the inner volume 106 of the nacelle 104 itself, instead of a central fuselage, provides an aircraft level advantage and a safety advantage over systems where the energy source is located in the fuselage. The central fuselage space is freed up for at least one, or both, of more payload and fuel cell powertrains within the fuselage. Fuel cells powertrains offer high specific energy (J/kg) but at a low energy density (J/m3) and power density (W/m3). When both batteries and fuel cells are used together, they are competing for space in the fuselage volume, which leads to a compromised solution. By placing the battery packs in the electric propulsion system (away from the fuselage), and the fuel cell powertrains in the fuselage, the aircraft can take advantage of having both sources of energy and power achieving a higher overall power density and specific energy than a traditional powertrain where only one of the two energy sources are chosen. The safety advantage is that all of the battery packs are not located in one central location on the aircraft close to the passengers/cargo, rather they are distributed in respective electric propulsion systems around the aircraft. In case of a single failure of a pack, the damage cannot propagate to all other battery packs.

Any and all examples can be realised in which the at least one fan stage comprising a fan bearing a plurality of aerodynamic surfaces/blades to generate thrust comprises a single such fan stage bearing a plurality of aerodynamic surfaces/blades to generate thrust.

Using ducted fans is more efficient than open propellers of the same diameter due to thrust generation from the duct itself. Further, the duct of the examples described herein, in addition to producing thrust, acts as a structural housing for the powertrain including the heat exchangers. The duct also acts as a safety shroud that protects the aircraft and payload in case of blade failure.

Examples can be realised according to the following clauses:

Clause 1: An electric propulsion system; the system comprising a nacelle comprising an aerodynamic annular housing defining an internal annular volume and defining an external inner duct, at least one fan stage comprising a fan bearing a plurality of aerodynamic surfaces/blades to generate thrust, and a powertrain comprising at least one electric motor to drive the fan and at least one electrical power source to power the at least one electric motor; and wherein the fan is disposed within the inner duct and the powertrain is disposed within the internal annular volume.

### Powertrain

Clause 2: The electric propulsion system of clause 1, in which the powertrain comprises one or more than one or more than one of the following, taken jointly and severally in any and all permutations: an engine control unit, at least one inverter or a power distribution system.

Clause 3: The electric propulsion system of any preceding clause, in which the at least one electrical power source comprises an energy system.

Clause 4: The electric propulsion system of clause 3, in which the energy system comprises an energy storage system such as, for example, at least one battery.

Clause 5: The electric propulsion system of clause 4, in which the energy system such as, for example, the at least one battery, comprises at least a partially toroidal form factor adapted to fit within the internal annular volume of the nacelle.

### Fuel Cell

Clause 6: The electric propulsion system of any preceding clause, in which the at least one electrical power source comprises a fuel cell to generate electrical power to power the at least one electric motor. The fuel cell can have at least a partially toroidal form factor adapted to fit within the internal annular volume of the nacelle

### Thermal Management

Clause 7: The electric propulsion system of any preceding clause, comprising a thermal management system disposed within the interior volume of the nacelle.

Clause 8: The electric propulsion system of clause 7, in which the thermal management system comprises a heat collection system carrying a heat absorbing medium.

Clause 9: The electric propulsion system of clause 8, in which the heat absorbing medium comprises a dielectric liquid.

Clause 10: The electric propulsion system of any of clauses 7 to 9, in which the heat collection system comprises a network carrying, comprising, or bearing, the heat absorbing medium; the network being common to multiple heat generating elements of powertrain.

Clause 11: The electric propulsion system of any of clauses 7 to 10, in which thermal management system comprises a heat redistribution network; the heat redistribution network being arranged to redistribute heat generated by the powertrain to one or more than one selectable portion of the electric propulsion system.

Clause 12: The electric propulsion system of clause 11, in which the heat redistribution network is arranged to redistribute heat generated by the powertrain to a heat exchanger arranged to vent heat into an aft portion of the inner duct for heating air within that inner duct.

Clause 13: The electric propulsion system of clause 12, in which the heat exchanger comprises a profiled surface adapted to radiate the heat into the inner duct.

Clause 14: The electric propulsion system of any of clauses 11 to 13, in which the heat redistribution network is arranged to redistribute heat generated by the powertrain to at least one, or more than one, of the following, taken jointly and severally in any and all permutations: a leading edge of a fore portion of the nacelle and a leading edge of the plurality of aerodynamic surface.

### Electric Drive Arrangements

Clause 15: The electrical propulsion system of any of preceding clause, in which the at least one electric motor comprises at least one rim driven electric motor.

Clause 16: The electric propulsion system of clause 15, in which the at least one rim drive electric motor comprises two rim driven electric motors operable to drive the at least one fan stage.

Clause 17: The electric propulsion system of clause 16, in which each rim driven electric motor of the two rim driven electric motors are operable at least one, or both, of: independently and simultaneously.

Clause 18: The electric propulsion system of any of preceding clause, in which the at least one electric motor is arranged to drive the at least one fan stage at above a threshold number of revolutions per minute, RPM.

Clause 19: The electric propulsion system of clause 18, in which the threshold RPM is 2000 RPM.

Clause 20: The electric propulsion system of any preceding clause, in which the at least one electric motor comprises at least one radial flux electric motor.

Clause 21: The electric propulsion system of clause 20, in which at least one radial flux electric motor comprises a stator and rotor; the stator and rotor being radially disposed relative to one another.

Clause 22: The electric propulsion system of clause 21, in which the stator is disposed radially outward relative to the rotor. Radial flux

Clause 23: The electric propulsion system of clause 21, in which the stator is disposed radially inward relative to the rotor (radial flux outrunner motor, i.e. inner coils, outer magnets). Radial flux

Clause 24: The electric propulsion system of any of clauses 21 to 23, in which the stator is disposed axially between rotor torus flanges (i.e. single internal stator and torus-shaped external rotor). Axial flux

Clause 25: The electric propulsion system of any of clauses 21 to 24, in which the rotor is disposed axially between the stators (i.e. Dual Stator single Inner Rotor or DSIR). Axial flux

Clause 26: The electric propulsion system of any of clauses 21 to 25, in which multiple DSIR or torus-type motors are longitudinally arranged in a tandem configuration. Axial flux

Clause 27: The electric propulsion system of any of clauses 21 to 26, in which at least one stator and rotor pair are arranged in a sectional cant angle relationship, via a circular cant, to implement conical flux. Convex rotor conical flux

Clause 28: The electric propulsion system of any preceding clause, in which the at least one electric motor to drive the fan comprises at least one electric motor comprising a stator and a plurality of sets of rotor magnets; the plurality of sets of rotor magnets being arranged orthogonally relative to one another. Radial and axial flux motors combined

Clause 29: The electric propulsion system of any of clauses 21 to 28, in which at least one stator and rotor pair are arranged in a sectional cant angle relationship, via at one or more than one circular cant to implement conical flux. Concave rotor conical flux

Clause 30: The electric propulsion system of clause 29, in which at least one stator and rotor pair are arranged in canted relationship to implement conical flux. Conical flux outrunner motor

Clause 31: The electric propulsion system of clauses 29 and 30 comprising a plurality of conically disposed electric motors, preferably arranged in a V-configuration; the plurality of conically disposed electric motors comprising an outer electric motor 124 and an inner electric motor 126. Double-V conical flux machine

### Fan Shroud

Clause 32: The electric propulsion system of any preceding clause, comprising a fan shroud for influencing at least one, or both, of: air flow associated with radially extremities of the aerodynamic surface/blades of the fan or noise generated by radially extremities of the aerodynamic surface/blades of the fan.

Clause 33: The electric propulsion system of clause 32, in which the fan shroud comprises a plurality of fixtures for mounting the aerodynamic surfaces/blades to the fan shroud.

Central Hub

Clause 34: The electric propulsion system of any preceding clause comprising a central hub on which the fan stage is rotatably mounted for rotation.

Clause 35: The electric propulsion system of any preceding clause, comprising a plurality of load transfer members to couple load generated in response to the thrust to load bearing members for coupling to an aircraft.

Clause 36: The electric propulsion system of clause 35, in which the plurality of load transfer members comprises a set of inlet guide vanes shaped to influence airflow into the fan stage.

Clause 37: The electric propulsion system of either of clauses 35 and 36, in which the plurality of load transfer members comprises a set of exit guide vanes shaped to influence airflow through an aft portion of the nacelle.

Clause 38: The electric propulsion system of any of clauses 34 to 37, in which the central hub comprise a bearing system for carrying the at least one fan stage; the bearing system being rotatable about a central axially disposed shaft.

### Three Parts

Clause 39: The electric propulsion system of any preceding clause, in which the nacelle comprises three section comprising a fore section, and aft section and a middle section; the fore section comprising a leading edge of the nacelle, middle section bearing the at least one fan stage and the aft section comprising a trailing edge or exhaust section of the nacelle.

Clause 40: The electric propulsion system of any preceding clauses, in which said at least one fan stage comprises only a single fan bearing a plurality of aerodynamic surfaces/blades to generate thrust.

Clause 41: The electric propulsion system of any preceding clauses, in which said powertrain comprises a single electric motor to drive the fan.

1. An electric propulsion system; the system comprising
a. a nacelle comprising an aerodynamic annular housing defining an internal annular volume and defining an inner duct,
b. a single one fan stage comprising a fan bearing a plurality of aerodynamic blades to generate thrust, and
c. a powertrain comprising at least one electric motor to drive the single fan stage and at least one electrical power source to power the at least one electric motor; and
d. wherein the fan is disposed within the inner duct and the powertrain is disposed within the internal annular volume.

2. The electric propulsion system of claim 1, in which the powertrain comprises one or more than one or more than one of: an engine control unit, at least one inverter, or a power distribution system taken jointly and severally in any and all permutations.

3. The electric propulsion system of any preceding claim in which the at least one electrical power source comprises an energy storage system.

4. The electric propulsion system of claim 3, in which the energy storage system comprises at least one battery.

5. The electric propulsion system of claim 4, in which the at least one battery comprises at least a partially toroidal form factor adapted to fit within the internal annular volume of the nacelle.

6. The electric propulsion system of any preceding claim, in which the at least one electrical power source comprises a fuel cell to generate electrical power to power the at least one electric motor.

7. The electric propulsion system of any preceding claim, comprising a thermal management system disposed within the interior volume of the nacelle.

8. The electric propulsion system of claim 7, in which the thermal management system comprises a heat collection system carrying a heat absorbing medium.

9. The electric propulsion system of claim 8, in which the heat absorbing medium comprises a dielectric liquid.

10. The electric propulsion system of either of claims 8 and 9, in which the heat collection system comprises a pipe network carrying the heat absorbing medium; the network being common to multiple heat generating elements of powertrain.

11. The electric propulsion system of any of claims 7 to 10, in which thermal management system comprises a heat redistribution network; the heat redistribution network being arranged to redistribute heat generated by the powertrain to one or more than one selectable portion of the electric propulsion system.

12. The electric propulsion system of claim 11, in which the heat redistribution network is arranged to redistribute heat generated by the powertrain to a heat exchanger arranged to vent heat into an aft portion of the inner duct for heating air within that inner duct.

13. The electric propulsion system of claim 12, in which the heat exchanger comprises a profiled surface adapted to radiate the heat into the inner duct.

14. The electric propulsion system of any of claims 11 to 13, in which the heat redistribution network is arranged to redistribute heat generated by the powertrain to at least one, or more than one, of the following, taken jointly and severally in any and all permutations: a leading edge of a fore portion of the nacelle or a leading edge of the plurality of aerodynamic surface.

15. The electrical propulsion system of any of preceding claim, in which the at least one electric motor comprises at least one rim driven electric motor.

16. The electric propulsion system of claim 15, in which the at least one rim drive electric motor comprises two rim driven electric motors operable to drive the single fan stage.

17. The electric propulsion system of claim 16, in which each rim driven electric motor of the two rim driven electric motors are operable at least one, or both, of: independently and simultaneously.

18. The electric propulsion system of any of preceding claim, in which the at least one electric motor is arranged to drive the single one fan stage at above a threshold number of revolutions per minute, RPM.

19. The electric propulsion system of claim 18, in which the threshold RPM is 2000 RPM.

20. The electric propulsion system of any preceding claim, in which the at least one electric motor comprises at least one radial flux electric motor.

21. The electric propulsion system of claim 20, in which at least one radial flux electric motor comprises a stator and rotor; the stator and rotor being radially disposed relative to one another.

22. The electric propulsion system of claim 21, in which the stator is disposed radially outward relative to the rotor.

23. The electric propulsion system of claim 21, in which the stator is disposed radially inward relative to the rotor.

24. The electric propulsion system of any of claims 21 to 23, in which the stator is disposed axially between rotor torus flanges.

25. The electric propulsion system of any of claims 21 to 24, in which the rotor is disposed axially between at least two stators.

26. The electric propulsion system of any of claims 21 to 25, in which multiple Dual Stator Single Inner Rotor motors or torus-type motors are longitudinally arranged in a tandem configuration.

27. The electric propulsion system of any of claims 21 to 26, in which at least one stator and rotor pair are arranged in a sectional cant angle relationship, via a circular cant, to implement conical flux.

28. The electric propulsion system of any preceding claim, in which the at least one electric motor to drive the fan comprises at least one electric motor comprising a stator and a plurality of sets of rotor magnets; the plurality of sets of rotor magnets being arranged orthogonally relative to one another.

29. The electric propulsion system of any of claims 21 to 28, in which at least one stator and rotor pair are arranged in a sectional cant angle relationship, via at one or more than one circular cant to implement conical flux.

30. The electric propulsion system of claim 29, in which at least one stator and rotor pair are arranged in canted relationship to implement conical flux.

31. The electric propulsion system of claims 29 and 30 comprising a plurality of conically disposed electric motors, preferably arranged in a V-configuration; the plurality of conically disposed electric motors comprising an outer electric motor 124 and an inner electric motor 126.

32. The electric propulsion system of any preceding claim, comprising a fan shroud for influencing at least one, or both, of: air flow associated with radially extremities of the aerodynamic blades of the fan or noise generated by radially extremities of the aerodynamic blades of the fan.

33. The electric propulsion system of claim 32, in which the fan shroud comprises a plurality of fixtures for mounting the aerodynamic blades to the fan shroud.

34. The electric propulsion system of any preceding claim comprising a central hub on which the fan stage is rotatably mounted for rotation.

35. The electric propulsion system of any preceding claim, comprising a plurality of load transfer members to couple load generated in response to the thrust to load bearing members for coupling to an aircraft.

36. The electric propulsion system of claim 35, in which the plurality of load transfer members comprises a set of inlet guide vanes shaped to influence airflow into the fan stage.

37. The electric propulsion system of either of claims 35 and 36, in which the plurality of load transfer members comprises a set of exit guide vanes shaped to influence airflow through an aft portion of the nacelle.

38. The electric propulsion system of any of claims 34 to 37, in which the central hub comprise a bearing system for carrying the at least one fan stage; the bearing system being rotatable about a central axially disposed shaft.

39. The electric propulsion system of any preceding claim, in which the nacelle comprises three sections comprising a fore section, and aft section and a middle section; the fore section comprising a leading edge of the nacelle, middle section bearing the at least one fan stage and the aft section comprising a trailing edge or exhaust section of the nacelle.

40. The electric propulsion system of any preceding claims, in which said powertrain comprises a single electric motor to drive the fan.
